(19) United States
(12) Patent Application Publication
(10) Pub. No.: US 2015/0106792 A1
(43) Pub. Date: Apr. 16, 2015

(54) METHOD OF PRESENTING TRACE DATA WITH IMPROVED EFFICIENCY BY USING HOSTED FORMATTED OUTPUT COMMANDS

(71) Applicant: Asset InterTech, Inc., Irvine, CA (US)

(72) Inventors: Lawrence A. Traylor, Irvine, CA (US); Harry S. Myers, Irvine, CA (US)

(73) Assignee: Asset InterTech, Inc., Irvine, CA (US)

(21) Appl. No.: 14/515,798

(22) Filed: Oct. 16, 2014

Related U.S. Application Data
(60) Provisional application No. 61/891,804, filed on Oct. 16, 2013.

(51) Int. Cl. G06F 11/36; G06F 11/30; G06F 11/32; G06F 11/34

(52) U.S. Cl. CPC G06F 11/364; G06F 11/3476; G06F 11/302; G06F 11/323
USPC 717/128

(57) ABSTRACT

A system and method of debugging application software operating on a system-on-chip processor (SOC) with a system trace macrocell.

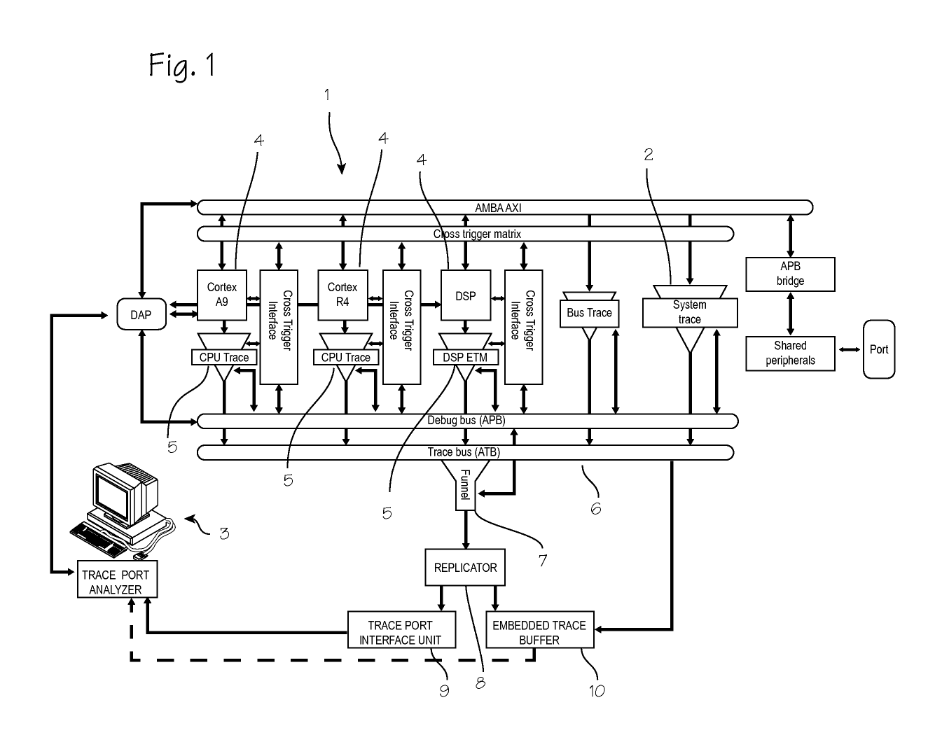

This application claims priority to U.S. Provisional Application 61/891,804 filed Oct. 16, 2013.

### FIELD OF THE INVENTIONS

The methods and systems described below relate to the field of hardware and software development.

### BACKGROUND OF THE INVENTIONS

The methods and systems described below provide for faster troubleshooting and debugging of software applications which are implemented with system-on-chip processors built with associated system trace macrocells. In these processors, the system trace macrocell (STM) provides data regarding the software execution to a separate device specifically designed to communicate with the system trace macrocell and collect the data. The collected data is transmitted from the system trace macrocell, through a trace bus, a trace port and trace port connector, to a trace port analyzer and then to a host computer which hosts debugging software, and can also be stored in a small buffer (an embedded trace buffer) in the system-on-chip accessible by the host computer.

Using the debugging software, such as Arium's SourcePoint™ debugging software, a software developer can view an on-screen display or a printout of the step-by-step operation of the software and processor. By viewing the report of the software operation correlated with the processor operation, the software developer can determine if the system is operating properly, and, if not, the software developer can determine exactly what steps of the software operation and/or processor are responsible for any improper operations.

The trace data from the system trace macrocell is transmitted to the general purpose computer hosting the debugging software, in a user-readable format, through a printf command. “Printf” refers to the formatted output command of the C programming language and other languages, and includes a c string (text) with embedded format specifiers (placeholders for data variables) that are replaced by the values specified in subsequent additional arguments. The output of this command is stored in the memory or storage of a computer, and may be recalled and displayed on a display where an engineer can read the output and analyze the data to find errors or inefficiencies in the processor and software operation. Typical printf output appears on the display as follows:
“The value of servocontrol is 99”.

The printf commands are executed by the application software, and the resultant data, including a text string (descriptive text), associated formatting, and variable values are then transmitted through the system trace macrocell, the trace bus, and trace funnel to the computer. This creates a large volume of data that must be transmitted. The application software may operate to create millions of formatted “trace messages.”

The ARM system trace macrocell can collect and transmit trace data from the processors. ARM processors and similar processors may also include embedded trace macrocells or program trace macrocells which provide trace data related to the execution of specific processes, in addition to the system trace data provided by the system trace macrocell. The embedded trace macrocell operates independently of the application software, and operates according to instructions set by the manufacturer of the system or by the debugging software, and is not altered by an application operating on the system. The embedded trace macrocells also generate voluminous trace data.

Each trace macrocell generates trace data and transmits it through a trace bus for eventual storage and display on a general purpose host computer. All trace data is transmitted to a trace bus (or buses) and a trace funnel (or funnels). The trace bus (or buses) and the trace funnel (or funnels) have limited capacity to transmit data (though each trace stream could be transmitted on a separate bus, this configuration is not implemented in ARM processors). A trace funnel manages the flow of trace data from the trace bus (or buses) to a storage device which interconnects the system-on-chip processor to the host computer, combining the several trace streams from the several trace macrocells into a single trace stream for transmission off-chip to the host computer). When the trace data exceeds the capacity of the trace bus and/or trace funnel, the excess trace data is discarded. Any errors or inefficiencies that might be reflected in discarded trace data will not be reflected in the trace data available to the user. Thus, it would be beneficial to reduce the amount of trace data generated by the application software and trace macrocells, to reduce the chance that trace data indicative of software failures is discarded.

### SUMMARY

The devices and methods described below provide for more efficient tracing of application software running on a system-on-chip processor. System trace data is transmitted through a system trace macrocell without first processing a printf command that generates a formatted trace message. The printf commands are instead executed on a host computer (a computer that hosts debugging software operable to display trace messages) rather than being generated in the application software. This reduces the size of the trace data stream that must be passed through the trace bus and trace funnel, and thus limits the amount of trace data that might be discarded by the normal processes of the trace bus and trace funnel.

### BRIEF DESCRIPTION OF THE DRAWINGS

The FIGURE is a schematic diagram of a system-on-chip processor system with a system trace macrocell, connected to a host computer.

### DETAILED DESCRIPTION OF THE INVENTIONS

The FIGURE is a schematic diagram of a system-on-chip processor system 1 with a system trace macrocell 2, connected to a host computer 3. The system may contain several processing elements (processors and/or DSP's 4) and their associated embedded trace macrocells (ETM 5). The system trace macrocell collects trace data related to the execution of the application software and system hardware. The several trace macrocells (items 2 and 5) transmit trace data through the trace bus 6 and trace funnel 7 to the host computer. The trace data may pass through a replicator 8, trace port interface unit 9, and/or an embedded trace buffer 10 (which stores trace data for later access by the host computer). The trace data, in the form of unformatted trace messages, is stored on the host computer. The host computer is programmed with debugging software, such as American Arium's SourcePoint™ software, which is operable when executed on the host computer to cause the host computer to create and to display and/or print formatted trace messages from the unformatted trace messages.

The system trace macrocell 2 traces system activity from software events and hardware events. The embedded trace macrocells 5 trace all the instructions executed by their associated processors. The system trace macrocell is a new component in system-on-chip processors. The system trace macrocell is a trace source for high bandwidth trace of instrumentation and embedded software. It detects writes (of trace data, written as directed by the application software) and converts them into STM trace data. Some of its functions can be controlled by the application software. In particular, the software events for which trace messages are generated can be controlled by the application software. The application software can include trace instructions, which when executed on the various processors in the system create trace data. As mentioned above, the application software can also include printf commands, which when executed on the various processors creates formatted trace messages, but this generates additional data that might result in overflow trace data. Overflow trace data is discarded by operation of the trace bus and trace funnel.

In the system the FIGURE, the debugging software on the host computer includes printf commands, and code enabling the user to apply printf commands to all, or selected portions of, the system trace data provided from the system trace macrocell. With this system, the application code may contain trace instructions, where desired, to create trace data, but need not contain printf commands that create formatted output readable by a person. In order to apply the printf command in the host computer, the application code trace instructions that create trace data need only instruct the system to create trace messages containing the following data:
format string addresses for print format commands (printf), without the printf format strings; and print format commands (printf) argument values.
   The application code need not execute printf commands. The application code need only contain application code to create trace messages containing trace data, but without formatted output that would be created by execution of a printf command. The host computer can then use this trace data to select the trace messages of interest, execute the printf command on those trace messages, and thus display or print formatted trace messages for the software designer to review.

The debugging software can be programmed to allow a user to select which of numerous unformatted trace messages to print using the hosted printf command on the host computer. The user can select masters and ports of interest, or all masters and ports, as necessary to review segments of software execution of interest. The debugging software thus includes commands to permit the user to enable and disable masters and ports, so that the user may select software steps executed on selected masters (processors within the system-on-chip) and selected ports on those masters.

This method, and the software and system that implements the method, can greatly reduce the volume of system trace data passing through the system trace macrocell, and thus reduce the amount of trace data that is discarded as overflow by the trace bus and trace funnel. A significant reduction in trace data can be achieved by replacing all printf commands in the application software with hosted printf commands in the debugging software operating on the host computer, such that the application software contains no printf commands. There may by situations where it is beneficial to retain some printf commands for trace messages in the application software (where, for example, an address format string may not be valid at a later time or available to the host computer), so that some trace instructions result in generation of trace messages, but the software application does not include associated printf commands. The system can still benefit from a substantial reduction in trace data by shifting a substantial number of printf commands to the host computer.

The debug software or separate software operable to perform the method described above can be embodied in a non-transitory computer readable media, which when executed in the host computer having a memory in which unformatted trace data from a system trace macrocell is stored causes the host computer to generate, store and display and print formatted trace messages containing the trace data from the system trace macrocell.

Though the methods and systems were developed and are illustrated here in reference to the ARM Coresight family of processors which include a system trace macrocell, they may be used with any processor with a system trace macrocell or instrumentation trace macrocell or comparable trace module which is operable to trace software execution of the application software.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of debugging application software operating on a system-on-chip processor (SOC) with a system trace macrocell, said method comprising the steps of:
running application software on the SOC, wherein said application software includes code which, when executed on the SOC generates unformatted trace messages;
operating a system trace macrocell on the SOC to transmit unformatted system trace messages to a host computer;
running debug software on the host computer, wherein said debug software is operable to execute print format commands on unformatted trace message to output a formatted trace message.

2. The method of claim 1, wherein the application software executed on the SOC includes trace instructions which, when executed on the SOC generate unformatted trace messages which include data including:
(1) a format string address; and
(2) unformatted argument values
and, for at least one trace message, the application software does not include an associated formatted print command.

3. The method of claim 1, wherein the application software executed on the SOC includes trace instructions which, when executed on the SOC generate unformatted trace messages which include data including
(1) a format string address; and
(2) unformatted argument values
and the application software does not include an associated formatted print command for any trace messages.

4. A system for analyzing system trace data generated from a system trace macrocell of a system-on-chip, said system comprising a computer operable to receive unformatted system trace messages from the system trace macrocell, said computer programmed to execute print format commands on the unformatted system trace messages to generate and display or print formatted trace messages.

5. A non-transitory computer readable medium storing a program, which when executed in a host computer having a memory in which unformatted trace data from a system trace macrocell is stored causes the host computer to generate and display or print formatted trace messages containing the trace data from the system trace macrocell.
